(19) United States
(12) Patent Application Publication
(10) Pub. No.: US 2025/0182358 A1
(43) Pub. Date: Jun. 5, 2025

(54) AMODAL SEGMENTATION BY SYNTHESIZING WHOLE OBJECTS

(71) Applicants: TOYOTA RESEARCH INSTITUTE, INC., LOS ALTOS, CA (US); THE TRUSTEES OF COLUMBIA UNIVERSITY IN THE CITY OF NEW YORK, NEW YORK, NY (US)

(72) Inventors: EGE OZGUROGLU, NEW YORK, NY (US); RUOSHI LIU, NEW YORK, NY (US); DIDAC SURIS COLL-VINENT, NEW YORK, NY (US); DIAN CHEN, MOUNTAIN VIEW, CA (US); ACHAL DAVE, SAN FRANCISCO, CA (US); PAVEL TOKMAKOV, SAN FRANCISCO, CA (US); CARL M. VONDRICK, NEW YORK, NY (US)

(73) Assignees: TOYOTA RESEARCH INSTITUTE, INC., LOS ALTOS, CA (US); TOYOTA JIDOSHA KABUSHIKI KAISHA, TOYOTA-SHI (JP); THE TRUSTEES OF COLUMBIA UNIVERSITY IN THE CITY OF NEW YORK, NEW YORK, NY (US)

(21) Appl. No.: 18/781,731

(22) Filed: Jul. 23, 2024

Related U.S. Application Data
(60) Provisional application No. 63/606,370, filed on Dec. 5, 2023.

(51) Int. Cl. G06T 11/60; G06T 5/50; G06T 5/70; G06T 7/12; G06V 10/26

(52) U.S. Cl. CPC G06T 11/60; G06T 5/50; G06T 5/70; G06T 7/12; G06V 10/26; G06T 2207/20221; G06V 2201/07

(57) ABSTRACT

Systems and methods are provided for generating amodal images from occlusions objects in input images. Examples herein include receiving a prompt selecting an object in an input image; applying the input image to a trained conditional generative model that generates an amodal image of the selected object based on the prompt and the input image; and outputting the amodal image.

### CROSS-REFERENCE TO RELATED APPLICATIONS

This application claims the benefit of U.S. Provisional Application No. 63/606,370 filed on Dec. 5, 2023, which is hereby incorporated herein by reference in its entirety.

### TECHNICAL FIELD

The present disclosure relates generally to computer vision, and in particular, some implementations may relate to zero-shot amodal segmentation from images, which generates amodal images by synthesizing amodal representations of objects that may be partially visible behind occlusions in input images.

### DESCRIPTION OF RELATED ART

Computer vision is an interdisciplinary field that deals with how computers can be made to gain understanding from digital images or videos. More particularly, computer vision techniques aim to provide for automatic extraction, analysis, and understanding of information from a single image or a sequence of images. This understanding can be provided as a transformation of images into descriptions of the contents of that image that make sense into information that can be understood by a computer and used to elicit action.

Machine vision may be an application of computer vision that uses the understanding obtained from the images or videos for image-based automation of systems and devices. Machine vision may refer to technologies, software and hardware products, integrated systems, actions, methods and expertise that use understanding gleaned from compute vision techniques to solve real-world problems.

### BRIEF SUMMARY OF THE DISCLOSURE

According to various embodiments of the disclosed technology, systems and methods for generating amodal images from occlusions objects in input images.

In accordance with some embodiments, a method is provided. The method comprises receiving a prompt selecting an object in an input image; applying the input image to a trained conditional generative model that generates an amodal image of the selected object based on the prompt and the input image; and outputting the amodal image.

In another aspect, a system is provided that comprises a memory storing instructions and a processor communicatively coupled to the memory. The processor is configured to execute the instructions to receive a prompt selecting an object in an input image; apply the input image to a trained conditional generative model that generates an amodal image of the selected object based on the prompt and the input image; and output the amodal image.

In another aspect, a non-transitory machine-readable medium is provided. The non-transitory computer-readable medium includes instructions that when executed by a processor cause the processor to perform operations including building a synthetically curated training dataset by generating training data pairs from source images, each training data pair comprising a training occluded image of an occluded object and a training counterpart image of a whole object corresponding to the occluded object; and conditioning a latent diffusion model to generate an amodal image of an occluded object in an input image based on the synthetically curated training dataset.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 is an illustrative representation of a computer system for implementing amodal synthetization in accordance with one or more embodiments of the present disclosure.

FIG. 2 depicts an example of an image dataset in accordance with one or more embodiments of the present disclosure.

FIG. 3 depicts a schematic block diagram of an example process for building a training dataset in accordance with one or more embodiments of the present disclosure.

FIG. 4 depicts various examples of amodal output images synthesized from input images, in accordance with embodiments disclosed herein.

FIG. 5 is a schematic block diagram of an example flow for amodal synthetization in accordance with one or more embodiments of the present disclosure.

FIG. 6 illustrates an example architecture for a computer vision system in accordance with one embodiment of the systems and methods described herein.

FIG. 7 provides example operations that may be carried out in connection with the computer implemented method, according to one or more embodiments of the present disclosure

FIG. 8 is an example computing component that may be used to implement various features of embodiments described in the present disclosure.

The figures are not exhaustive and do not limit the present disclosure to the precise form disclosed.

### DETAILED DESCRIPTION

Embodiments of the systems and methods disclosed herein can provide for a computer vision framework for zero-shot amodal segmentation. The examples herein can learn to estimate complete, whole shapes and appearances of objects that are partially visible behind occlusions in an digital image. Implementations disclosed herein utilize latent diffusion models to train a conditional diffusion model, which can be employed to synthesize complete, whole representations of occluded objects contained in digital images. That is, the conditional diffusion model may be trained to reconstruct an object contained in an image (or sequence of images), including any portions thereof occluded by other objects in the image (or sequence of images). Examples herein transfer representations from the latent diffusion models to learn the conditional diffusion model. By leveraging the latent diffusion model to train the conditional diffusion model, examples herein can be utilized for zero-shot applications, such as where the trained conditional diffusion model has not observed or otherwise been exposed to an image from which a complete, whole representation (sometimes referred to herein as an amodal image) of an occluded object can be synthesized. Accordingly, examples herein can be used to improve the performance of existing object recognition and 3D reconstruction methods in the presence of occlusions, for example, by reconstructing complete instances of occluded objects.

Amodal completion is the task of predicting a whole shape and appearance of objects that are not fully visible, and this ability can be crucial for downstream machine vision applications, such as graphics and robotics. Learned by children from an early age, the ability can be partly explained by experience, but humans seem to be able to generalize to challenging situations that break natural priors and physical constraints with ease.

What makes amodal completion challenging compared to other synthesis tasks is that it relies on grouping for both visible and hidden parts of an object. To complete an object, the object must be recognized from partial observations and then synthesize the missing regions of the object. Computer vision researchers and gestalt psychologists have extensively studied amodal completion in the past, creating models that explicitly learn figure-ground separation. However, the prior work has been limited to representing objects in closed-world settings, and are limited to accurately operating only on the datasets on which they trained.

Examples herein provide an approach for zero-shot amodal segmentation and reconstruction by learning to synthesize whole objects. As alluded to above, examples herein obtain amodal representations of objects from pre-trained latent diffusion models. These latent diffusion models are trained on representations of a natural image manifold and capture numerous different instances objects, including whole instances and occluded instances. In examples, the diffusion models can be trained on a large distribution of training data, and due to this large-scale training the diffusion model may have learned both amodal and occluded representations. In some examples, the diffusion models may be trained on Internet-scale data. In the context of latent diffusion models, Internet-scale data may refer to sampling training data, such as digital images, from across a significantly large portion of the entire Internet, with an aim at covering the entire Internet. Examples herein denoise the latent diffusion models and construct a synthetic dataset by reconfiguring amodal representations and encoding object groupings pairs. An object grouping pair may refer to a pair of images including an image of an occluded object and an image of the occluded objects whole counterpart. By learning from a synthetic dataset of amodal representations and their whole counterparts, examples herein can train a conditional diffusion model that, given an input digital image and a point prompt, can generate whole objects of occluded objects that are otherwise located behind occlusions and other obstructions in the input digital image.

Accordingly, examples herein are able to achieve state-of-the-art amodal segmentation applicable to zero-shot applications, which outperforms conventional methods that were specifically supervised on particular benchmarks. Examples herein can be used as a drop-in module to improve the performance of existing object recognition and 3D reconstruction applications in the presence of occlusions. An additional non-limiting benefit of the examples disclosed herein is that they provide for sampling several variations of the reconstruction and handling any inherent ambiguity of the occlusions.

As used herein, amodal completion will be used to refer to the task of generating an image of a whole object. Amodal segmentation, as used herein, will be used to refer to the task of generating a segmentation mask of the whole object. Amodal detection, as used herein, will be used to refer to predicting a bounding box of a whole object. Most conventional approaches focus on the latter two tasks, due to the challenges in generating information of for pixels—possible ambiguous pixels—that are located behind an occlusion. In addition, the conventional approaches are generally limited to small closed-world of objects. For example, one prior approach for amodal segmentation operates only on a closed world set of object classes contained in training dataset. Whereas, examples of the presently disclosed technology, provide rich object completions with accurate masks, generalizing to diverse zero-shot applications, while outperforming the conventional closed-world approaches. To assist in achieving this degree of generalization, along with other aspects of the presently disclosed technology, examples herein leverage the large-scale latent diffusion models, as discussed above. Examples are able to leverage the large-scale diffusion models by fine-tuning the latent diffusion models on a synthetically generated, realistic dataset of varied occlusions obtained from the latent diffusion models themselves, which can be used to train the conditional diffusion mode according to the examples disclosed herein.

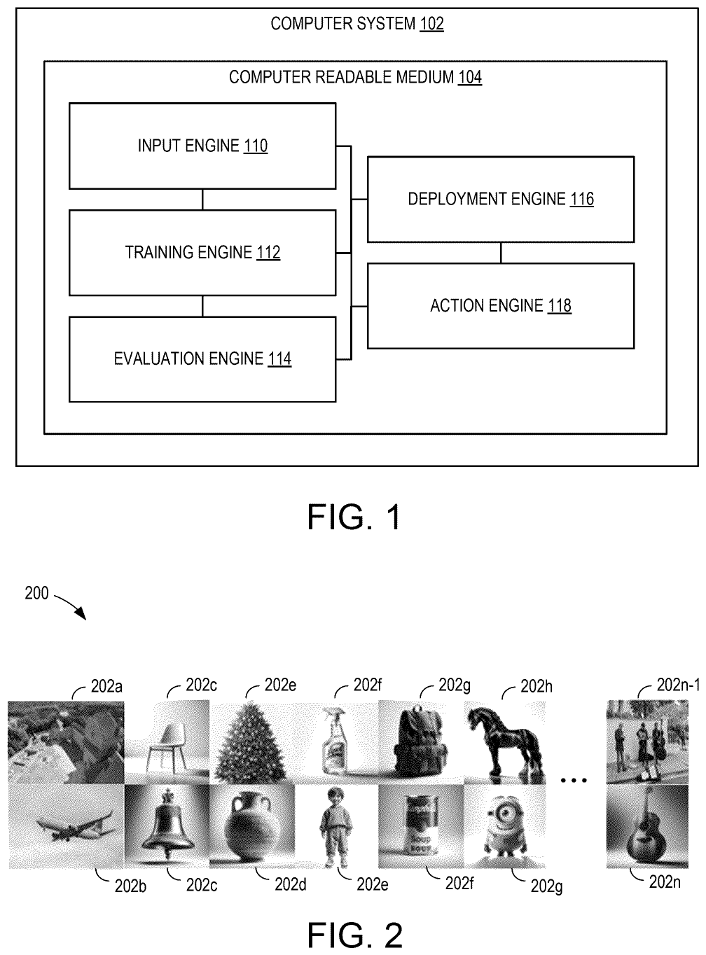

FIG. 1 is an illustrative representation of a computer system for implementing amodal synthetization in accordance with one or more embodiments of the present disclosure. Computer system 102 may comprise computer readable medium 104, input engine 110, training engine 112, evaluation engine 114, deployment engine 116, and action engine 118. Other components and engines (e.g., processor, memory, etc.) have been removed from the illustration of computer system 102 in order to focus on these features.

Input engine 110 is configured to receive and/or store input training data. For example, input engine 110 may interact with a receiver configured to receive input data from one or more sources. In examples, input training data may be data collected as a dataset comprising a plurality of images. In some examples, the datasets may be Internet-scale datasets comprising a larger number of digital images. Example datasets may include, but are not limited to, the Amodal COCO (COCO-A) dataset, such consists of 13,000 amodal annotations for 2,500 images, and Amodal Berkely Segmentation (BSDS-A) dataset, which consists of 350 objects from 200 images. While examples herein are described with reference to digital images, embodiments disclosed herein are not limited to single images. The input training data may comprise videos as a sequence of images that can be used for training.

FIG. 2 depicts an example of an input training dataset 200. The training dataset 200 comprises a plurality of digital images 202a-202n. Each image may be provided pixels and corresponding information (e.g., RGB information defining each pixel) that renders the respective image. In examples, each image 202a-202n may be associated with amodal annotations of whole objects contained in the respective image. For example, image 202a may be associated with an amodal annotation of “fortress”, image 202b may be associated with an amodal annotation of “airplane”, and so on. While FIG. 2 illustrates a particular number of images, this if for illustrative purposes only. Example input datasets herein are not limited to only the number of images shown, for example, as described above, the COCO-A and BSDS-A datasets consist of 13,000 amodal annotations for 2,500 images and 350 amodal annotations for 200 images, respectively.

Returning to FIG. 1, the input engine 110, in some examples, can be configured to generate a synthetically curated training dataset from the input training data. For example, the input engine 110 may be configured to build the synthetically curated training dataset as training data pairs, each pair comprising an occluded object and its whole counterpart. That is, each training data pair comprises an image containing an occluded object and an image containing a representation of the whole object, absent inclusion. In this way, the training data pair contains pixel information for representing both an occluded object and its whole object counterpart.

Unfortunately, collecting a natural image dataset of these pairs can be challenging at Internet-scale. For example, existing datasets (e.g., COCO-A, BSDS-A, and the like) provide amodal segmentation annotations for images, but these datasets do not provide any information of pixels that would be behind an occlusion. Other datasets have relied on graphical simulation, which lack the realistic complexity and scale of everyday object categories.

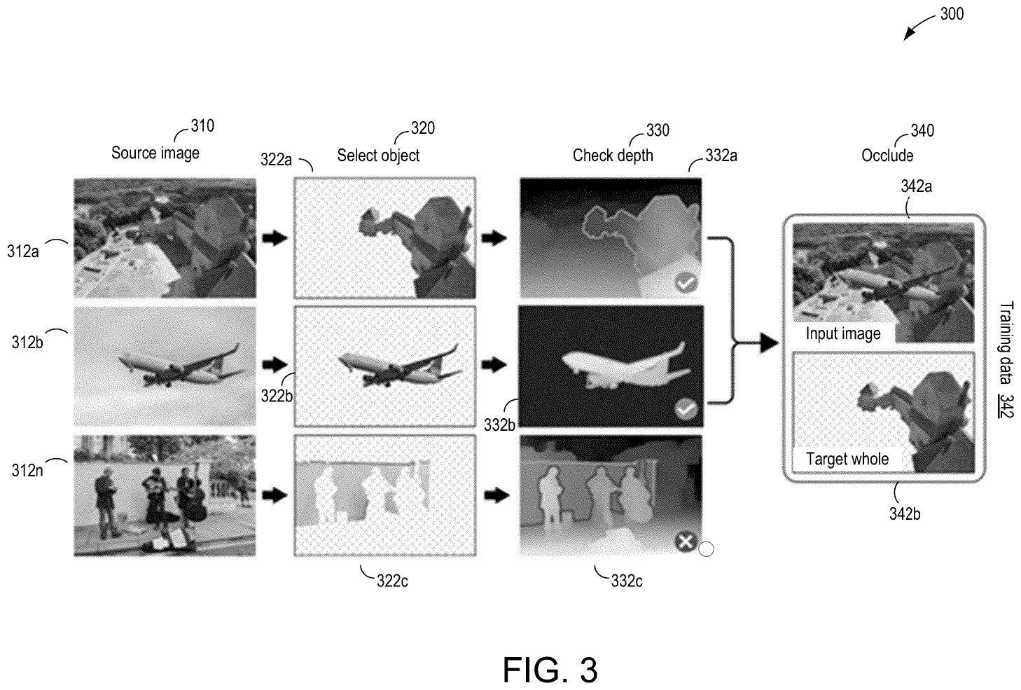

In examples, the input engine 110 may be configured to build training dataset by automatically overlaying objects over natural images to generate training data pairs. FIG. 3 depicts a schematic block diagram of an example process 300 that may be executed by training engine 110 to construct a training data pair. At step 310, source images 312a-312n are obtained from the input training data. In examples, source images 312a-312n may comprises the entirety of the input training data or a subset thereof. For example, FIG. 3 depicts image 202a from FIG. 2 as source image 312a, image 202b as source image 312b, and image 202n-1 as source image 312n. In the example of FIG. 3, three images are shown for illustrative purposes, but in examples, the entire input training dataset may be processed in parallel.

At step 320, objects contained in each image are selected and backgrounds removed to generate counterpart image 322a-322b. In some cases, a source image may contain multiple objects and a counterpart image may be generated for each object. For example, in the case of source image 312n, there are three people (e.g., objects) in front of a wall (e.g., another object). For this example, the objected selected by input engine 110 for consideration is the wall. However, additional selected object images may be generated from source image 312n, such as an image containing one of the persons. In some examples, input engine 110 may execute a segmentation algorithm, such as Segment Anything or the like as known in the art, to automatically find candidate objects for generating the selected object images.

At step 330, a check is performed to ensure only whole objects are selected used for generating a training data pair. Whole objects contained in source images 312a-312n, as represented by counterpart images 322a-322n, can provide ground-truth for the content behind occlusions in the training data pair. Thus, input engine 110 may be configured to ensure that only occlude whole objects are used to construct a training data pair, as otherwise examples herein may learn to generate incomplete objects. To this end, input engine 110 may use a heuristic that, if the object is closer in depth than its neighboring objects, then it is likely a whole object. To perform the analysis, input engine 110 may execute a monocular depth estimator, such as MiDaS or the like, to select check the depth and select objects are whole. As shown in FIG. 3, check marks are shown indicating that image check 332a and image check 332b the outlined object has an estimated depth that is closer than its background, while the “x” mark on image check 332b indicates that the outlined object is further away than other objects (e.g., persons in this example).

At step 340, for each source image with at least one whole object, input engine 110 constructs a corresponding training data pair 342 from the source image and its counterpart image. For example, input engine 110 selects a first source image containing a whole object and selects a counterpart image of a second source image containing another whole object. The input engine 110 generates a training occluded image by superimposing (e.g., overlaying) the counterpart image of the second source image over the first source image in a way to occlude the whole object of the first source image. The counterpart image of the first source image is then associated with the training occluded image as a training amodal image. The training occluded image and the training amodal image pair constitute a training data pair. The process is performed for each image with at least one whole object to generate a plurality of training data pairs to provide the synthetically curated training dataset.

In the example of FIG. 3, input engine 110 generates training data pair 420 for source image 312a containing a whole object (e.g., the fortress). For example, input engine 110 selects source image 312a as containing a whole representation of the fortress (e.g., source image 312a contains all necessary pixel information for rendering the whole fortress) and selects counterpart image 322b as containing a whole representation of the airplane. Input engine 110 then generates training occluded image 342a by superimposing the counterpart image 322b on to the source image 312a such that the airplane occludes at least part of the fortress. The input engine 110 associates the counterpart image 322a with the training occluded image 342a as training amodal image 342b. The pair of images 342a and 342b constitute a training data pair 342. The training occluded object 342a contains an occlusion of the fortress, while the training amodal image 342b provide a ground-truth for the information for rendering the pixels of the fortress that are occluded by the airplane.

Returning to FIG. 1, in examples, input engine 110 may also be configured to receive input prompts that select an object from an input image. For example, input engine 110 may be communicatively connected to a user interface or input device for communicating information and command selections from a user to the input engine 110. Examples of user interfaces or input devices may include, but are not limited to, alphanumeric and other keys, a mouse, a trackball, or cursor direction keys. In some examples, the information and command selections may be implemented via receiving touches on a touch screen without a cursor.

Training engine 112 is configured to train a generative model using the input training data. The training data may comprise the data collected by input engine 110. In various examples, the training data may comprise the synthetically curated training dataset comprising pairs of training occluded images and their amodal image counterparts, as described above.

Training engine 112 may comprise an generative algorithm that is applied to the training data to generate the generative model. In examples, the generative algorithm may be a diffusion algorithm that represents a pre-trained latent diffusion model. Training of the generative model may comprise conditioning the latent diffusion model using training data to estimate complete, whole shapes and appearances of objects that are partially visible behind occlusions in an digital image. The training engine 112, in examples, may condition the latent diffusion model using input data, such as the synthetically curated training dataset, to train a conditional diffusion model to reconstruct a whole representation of an object contained in an image, including any portions thereof occluded by other objects in the image. The training engine 112 may obtain the synthetically curated training dataset and train the conditional diffusion model to, given an input image and a prompt from the input engine 110, can generate whole objects of occluded objects that are otherwise located behind occlusions and other obstructions in the input image.

The evaluation engine 114 can be configured to assess performance of the training based on a testing dataset. The testing dataset may comprise a plurality of images that the training engine 112 did not have exposure while training the generative model. The testing dataset may be images obtained by input engine 110, as well as pairs of images and their whole counterparts (referred to herein as testing occluded images and corresponding testing counterpart images). The pairs used for evaluating the generative model may be generated in a manner similar to the training data pairs, as described in connection with FIG. 3. The deployment engine 116 may be configured to deploy a trained generative model on a robotic system when the performance evaluated by the evaluation engine 114 meets a desired accuracy. The deployment engine 116 executes the deployed trained generative model (e.g., the conditional diffiusion model) by action engine 118.

Action engine 118 may be configured to, given an input image and a prompt from the input engine 110, generate an amodal output image of a representation of whole objects of objects (e.g., occluded object) in the input image. Action engine 118 may receive one or more prompts from input engine 110 that select an object from the input image and apply the trained generative diffusion model to the input image based on the prompts. The action engine 118 executes the trained generative model to synthesize pixel information for the selected object to reconstruct the selected object, including an regions of the selected object that are occluded in the original input image. Action engine 118 may then output the pixel information as an amodal output image of the selected object.

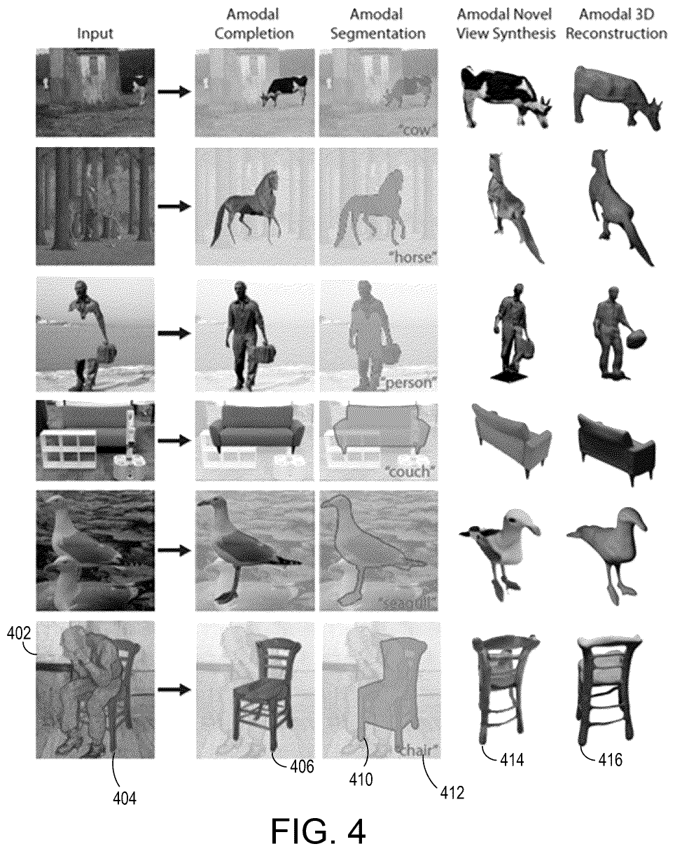

In some embodiments, action engine 118 may utilize the amodal output image for various computer visions applications, such as but not limited to, image segmentation, object recognition, 3-dimensional (3D) reconstruction, view synthesis, and the like. FIG. 4 depicts various examples of amodal output images synthesized from input images and used for computer vision applications, in accordance with embodiments disclosed herein. As an example, input image 302, containing a painting of a chair 304 occluded by a person, may be received by input engine 110. Prompts may be received selecting the chair 302. Action engine 118 may apply the trained generative model to the input image 302 and generate an amodal output image 306 as a representation (e.g., pixel information) of the whole chair 302, which can be used for various computer vision applications.

In an example, action engine 118 may apply the amodal output image 306 to an image segmentation algorithm, as known in the art, to generate an amodal segmentation map 310 of the chair 302. Image Segmentation aims to find spatial boundaries of an object given an image and a prompt. The action engine 118 may perform amodal segmentation by obtaining the amodal output image 302 and thresholding a segmentation algorithm to obtain an amodal segmentation map 310. Examples herein may sample multiple amodal output images of the object (e.g., executing the trained generative model on the same input image multiple times) and performing a majority vote on the segmentation map 310 to obtain a best result.

In some examples, action engine 118 may execute an object recognition algorithm, as known in the art, to recognize the amodal output image 306 to provide object recognition output 312 (e.g., “chair”). Object Recognition is the task of classifying an object located in an bounding box or mask. The action engine 118 may be configured to recognize objects by obtaining the amodal output image 302 and classifying the amodal output image 302 with Contrastive Language-Image Pretraining (CLIP) embeddings.

In yet another example, may execute a view synthesis algorithm to generate a view of the chair 302 from a perspective that differs with respect to the input image.

In yet another example, action engine 118 may execute a 3D reconstruction algorithm, as known in the art, to construct a 3D representation 316 of the chair 302 from. 3D Reconstruction estimates the appearance and geometry of an object. In this case, the action engine 118 may obtain the amodal output image 302 and apply, for example, SyncDreamer and Score Distillation Sampling to estimate a textured mesh of polygons that form 3D representation 316.

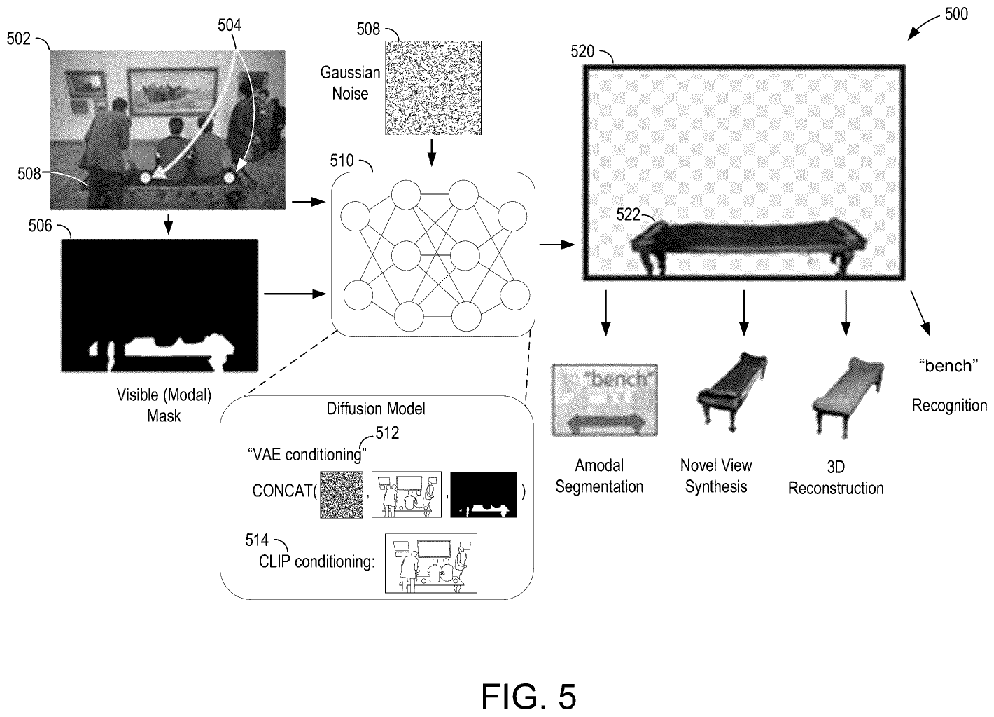

FIG. 5 is a schematic block diagram of an example flow 500 for amodal synthetization in accordance with one or more embodiments of the present disclosure. Given an RGB input image 502 with an occluded object that is partially visible, examples herein predict a new image with the shape and appearance of the whole of the occluded object. In examples, the flow 500 outputs an amodal image (also referred to as an amodal output image) of only the whole of the occluded object. In the example of FIG. 5, impute image 502 contains people occluding a bench 508. The flow 500, in an example, outputs an amodal image 520 containing a representation 522 of only the bench 508. Flow 500 uses a pretrained conditional diffusion model 510 to synthesize the pixel information of the bench 508, particularly information for the occluded regions of bench 502, to construct the amodal image 520.

In more detail, flow 500 obtains the input image 502 and one or more prompts 504 indicating a modal object (e.g., an object in input image 502 selected for synthesizing an amodal image thereof). In the example of FIG. 5, the bench 508 is the indicated modal object and will be referred to herein as modal object 508. In some examples, prompts 504 may be received from a user via an input device interacting with a graphic user interface. The user, for example, may select one or more visible regions of the modal object 508 using an input device, which provides the selection as prompts 504. A visible mask (also referred to as a modal mask) 506 can be generated based on the prompts 504. The modal mask 506 is binary representation of the selected modal object. The input image 502 and prompts 504 may be obtained by, for example, the input engine 110 of FIG. 1. The input engine 110 may also generate the modal mask 506 from the input image 502 based on the prompts 504.

The input image 502 and modal mask 506 are provided to the conditional diffusion model 510, which is trained to estimate of the whole of the modal object 502 as \hat{x}ₚ as:

$${\hat{x}}_{p} = {f}_{θ} ( x , p ) \qquad Eq . 1$$

where x represents the input image 502; p represents the prompts 504; and f_{θ} represents the algorithm constituting the trained conditional diffusion model. Mapping from the input image 502 (x) to the whole form, e.g., gestalt of the model object, the conditional diffusion model may be referred to as pix2gestalt. Examples herein aim to bring \hat{x}ₚ as perceptually similar (e.g., within a set performance in term of accuracy) to the true but unobserved whole of the modal object 506 as if there are no occlusions. Eq. 1 may be computed by, for example, action engine 118 using the conditional diffusion model 510 as f_{θ}, where the conditional diffusion model 510 may be trained by the training engine 112 of FIG. 1.

A non-limiting advantage of the examples herein is that, once an estimate an amodal image 522 of the whole object \hat{x}ₚ (e.g., representation 522 of only the bench in FIG. 5), examples herein can perform any other computer vision task using the amodal image 522. Thus, a unified method can be provided to handle occlusions across different computer vision tasks, as described above. Since examples herein directly synthesize the pixel information of the whole object \hat{x}ₚ, examples herein can aid off-the-shelf approaches to perform image segmentation, object recognition, view synthesis, and 3D reconstruction of occluded objects contained in input images, as described above with reference to FIG. 4.

As alluded to above, to perform amodal completion and generate amodal images of occluded objects, the condition diffusion model 510 (e.g., f_{θ} in Eq. 1) may need to learn a representation of the whole object in the visual world. Accordingly, due to their scale of training data, examples herein capitalize on large pretrained latent diffusion models, such as, but not limited to, Stable Diffusion. These latent diffusion models contain representations (e.g., images) of the natural image manifold and have the support to generate un-occluded objects, as known in the art. However, although they generate high-quality images, their representations do not explicitly encode grouping of objects and their boundaries to the background.

To train the conditional diffusion model 510 with the ability for grouping, examples herein build synthetically curated training dataset of training occluded images containing occluded objects and training counterpart images contain their whole counterparts, as described above with reference to FIG. 3. The training data pairs of the synthetically curated training dataset can be used to train the conditional diffusion model 510, for example, by using a training occluded image as an input image into the latent diffusion model and conditioning the diffusion model to reconstruct the training counterpart image.

More particularly, given pairs of training occluded images as an input images (x) and corresponding counterpart images as an amodal targe image (\hat{x}ₚ) (e.g., the whole object) examples herein can fine-tune the conditional diffusion model 510 to perform amodal completion while maintaining zero-shot capabilities of the pre-trained latent diffusion model. For example, training may include solving the following latent diffusion objective for a minimum:

$${min}_{θ} {𝔼}_{z \sim ℰ ( x ) , t , ϵ \sim 𝒩 ( 0 , 1 )} [ {‖ ϵ - {ϵ}_{θ} ( {𝓏}_{t} , ℰ ( x ) , t , ℰ ( p ) , 𝒞 ( x ) ) ‖}_{2}^{2} ] \qquad Eq . 2$$

where 0≤t≤1000 is the diffusion time step; zₜ is the embedding of a noised amodal target image \hat{x}ₚ; [symbol] (x) is the CLIP embedding of the input image; ε(x) is a variational autoencoder (VAE) embedding for the input image (x); ε(p) is a variational autoencoder embedding for the modal image computed from the prompts (p); and [symbol] is a noise function applied to the amodal target image \hat{x}ₚ. In examples, the noise function may be provided as Gaussian noise. In examples, a classifier-free guidance (CFG) may set the conditional information to a null vector randomly.

Amodal completion may rely on reasoning about the whole shape, its appearance, and contextual visual cues of the scene of an input image. Examples herein condition the latent diffusion model Ee in two separate streams: a CLIP stream 514 and a VAE stream 512. C (x) conditions the latent diffusion model Ee via cross-attention on the semantic features of the modal object in the input image (x) as specified by prompts (p), providing high-level perception. On the VAE stream, examples channel concatenate ε(x) and zₜ, providing low-level visual details (e.g., shade, color, texture), as well as ε(p) to indicate the visible region of the modal object.

Once the latent diffusion model Ee is conditioned, the conditional diffusion model 510 (f_{θ}) can generate amodal images (\hat{x}ₚ) of input images that were not used in training. For example, input image 502 and prompts 504 (and/or modal mask 506) can be provided to the trained conditional diffusion model 510 (f_{θ}). The input image 502 can be noised, for example, by applying a noise function (e.g., Gaussian noise) to the input image 502. The conditional diffusion model 510 (f_{θ}) can then iteratively denoise the noised input image to estimate an amodal representation of the modal object 508 specified by the prompts 504. The conditional diffusion model 510 (f_{θ}) synthesizes pixel information of the amodal representation 522 and outputs the amodal image 520. The CFG can be scaled to control impact of the conditioning on the completion.

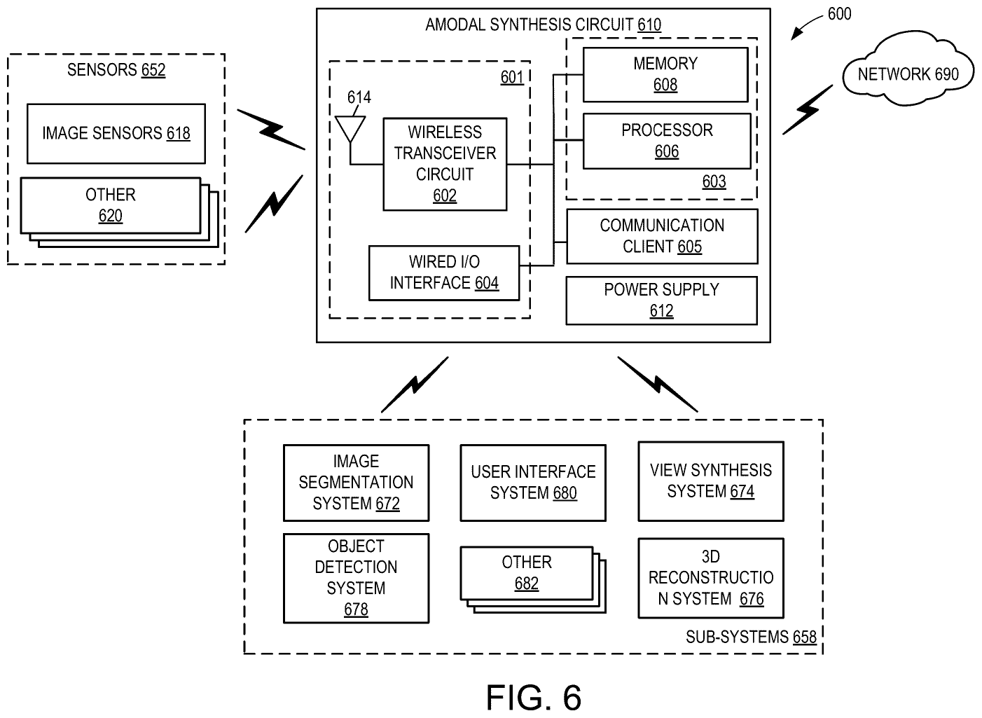

FIG. 6 illustrates an example architecture for a computer vision system in accordance with one embodiment of the systems and methods described herein. The computer vision system 600 of FIG. 6 can be implemented as, for example, a robotic system, vehicle systems, or any system that utilizes computer vision techniques. For example, embodiments disclosed herein can be implemented on any autonomous or semi-autonomous systems, such as on vehicles, for performing amodal synthesis according to the examples disclosed herein.

Referring now to FIG. 6, in this example, computer vision system 600 comprises an amodal synthesis circuit 610. The amodal synthesis circuit 610 comprises a plurality of sensors 652 and a plurality of sub-systems 658. Sensors 652 and systems 658 can communicate with amodal synthesis circuit 610 via a wired or wireless communication interface. Although sensors 652 and systems 658 are depicted as communicating with amodal synthesis circuit 610, they can also communicate with each other as well as with other vehicle systems. In some examples, amodal synthesis circuit 610 can be implemented as an ECU or as part of an ECU such as, for example electronic control unit of a vehicle. In other embodiments, amodal synthesis circuit 610 can be implemented independently of an ECU.

Amodal synthesis circuit 610 in this example includes a communication circuit 601, a decision circuit 603 (including a processor 606 and memory 608 in this example) and a power supply 612. Components of amodal synthesis circuit 610 are illustrated as communicating with each other via a data bus, although other communication in interfaces can be included. Amodal synthesis circuit 610 in this example also includes communication client 605 that can be operated to connect to remote devices and systems, such as an edge or cloud server, via a network 690 for uploading and/or downloading information to or from remote systems.

Processor 606 can include one or more GPUs, CPUs, microprocessors, or any other suitable processing system. Processor 606 may include a single core or multicore processor. The memory 608 may include one or more various forms of memory or data storage (e.g., flash, RAM, etc.) that may be used to store instructions and variables for processor 606 as well as any other suitable information. Memory 608 can be made up of one or more modules of one or more different types of memory, and may be configured to store data and other information as well as operational instructions that may be used by the processor 606 to amodal synthesis circuit 610. Memory 608 may store input images, training data, and the like. In an example, memory 608 may store one or more modules that when executed by the processor 606 operate as the various special-purposes engines described in connection with FIG. 1.

Although the example of FIG. 6 is illustrated using processor and memory circuitry, as described below with reference to circuits disclosed herein, decision circuit 603 can be implemented utilizing any form of circuitry including, for example, hardware, software, or a combination thereof. By way of further example, one or more processors, controllers, ASICs, PLAS, PALs, CPLDs, FPGAs, logical components, software routines or other mechanisms might be implemented to make up a amodal synthesis circuit 610.

Communication circuit 601 includes either or both a wireless transceiver circuit 602 with an associated antenna 614 and a wired I/O interface 604 with an associated hardwired data port (not illustrated). In embodiments where computer vision system 600 is implemented as vehicle, communication circuit 601 can provide for vehicle-to-everything (V2X) and/or vehicle-to-vehicle (V2V) communications capabilities, allowing amodal synthesis circuit 610 to communicate with edge devices, such as roadside unit/equipment (RSU/RSE), network cloud servers and cloud-based databases, and/or other vehicles via network 690. For example, V2X communication capabilities allows amodal synthesis circuit 610 to communicate with edge/cloud servers, roadside infrastructure (e.g., such as roadside equipment/roadside unit, which may be a vehicle-to-infrastructure (V2I)-enabled street light or cameras, for example), etc. Amodal synthesis circuit 610 may also communicate with other connected vehicles over vehicle-to-vehicle (V2V) communications.

As this example illustrates, communications with amodal synthesis circuit 610 can include either or both wired and wireless communications circuits 601. Wireless transceiver circuit 602 can include a transmitter and a receiver (not shown) to allow wireless communications via any of a number of communication protocols such as, for example, Wi-Fi, Bluetooth, near field communications (NFC), Zigbee, and any of a number of other wireless communication protocols whether standardized, proprietary, open, point-to-point, networked or otherwise. Antenna 614 is coupled to wireless transceiver circuit 602 and is used by wireless transceiver circuit 602 to transmit radio signals wirelessly to wireless equipment with which it is connected and to receive radio signals as well. These RF signals can include information of almost any sort that is sent or received by amodal synthesis circuit 610 to/from other entities such as sensors 652 and systems 658.

Wired I/O interface 604 can include a transmitter and a receiver (not shown) for hardwired communications with other devices. For example, wired I/O interface 604 can provide a hardwired interface to other components, including sensors 652 and systems 658. Wired I/O interface 604 can communicate with other devices using Ethernet or any of a number of other wired communication protocols whether standardized, proprietary, open, point-to-point, networked or otherwise.

Power supply 612 can include one or more of a battery or batteries (such as, e.g., Li-ion, Li-Polymer, NiMH, NiCd, NiZn, and NiH2, to name a few, whether rechargeable or primary batteries,), a power connector (e.g., to connect to robotic system supplied power, etc.), an energy harvester (e.g., solar cells, piezoelectric system, etc.), or it can include any other suitable power supply.

Sensors 652 can include additional sensors that may or may not otherwise be included on a standard systems with which the computer vision system 600 is implemented. In the illustrated example, sensors 652 is equipped with one or more image sensors 618. These may include front facing image sensors, side facing image sensors, and/or rear facing image sensors. Image sensors may capture information which may be used in detecting not only conditions of the computer vision system but also detecting conditions external thereto as well. Image sensors that might be used to detect external conditions can include, for example, cameras or other image sensors configured to capture data in the form of sequential image frames forming a video in the visible spectrum, near infra-red (IR) spectrum, IR spectrum, ultra violet spectrum, etc. The image frames obtained by the image sensors 618 can be used to, for example, to detect objects in an environment surrounding the computer vision system 600. As another example, object detection and recognition techniques may be used to detect objects and environmental conditions. Additionally, sensors may estimate proximity between robotic system 695 and other objects in the surrounding environment. For instance, the image sensors 618 may include cameras that may be used with and/or integrated with other proximity sensors such as LIDAR sensors or any other sensors capable of capturing a distance.

Additional sensors 620 can also be included as may be appropriate for a given implementation of computer vision system 600. For example, sensors 620 may include accelerometers such as a 6-axis accelerometer to detect roll, pitch and yaw of the computer vision system, environmental sensors (e.g., to detect salinity or other environmental conditions), and proximity sensor (e.g., sonar, radar, lidar or other vehicle proximity sensors). In the case of computer vision system 600 implemented as a vehicle, sensors that are standard on a vehicle may also be included as part of sensor 652.

Sub-systems 658 can include any of a number of different components or subsystems used to control or monitor various aspects of the computer vision system 600 and its performance. In this example, the sub-systems 658 may include one or more of: object detection system 678 to perform image processing such as object recognition and detection on images from image sensors 618, proximity estimation, for example, from image sensors 618 and/or proximity sensors, etc. for use in other sub-systems; image segmentation system 672 for generating amodal segmentation maps of objects in images from image sensors 618; view synthesis system 674 for generating alternative views of an object contained in images from the image sensors 618; and 3D reconstruction system 676 for generating a 3D polygon mesh of an object contained in the images from the image sensor 618. Sub-systems 658 may also include a user interface system 680 that receives inputs from a user via an input device (e.g., keyboard, mouse, trackball, cursor direction, gestures received by a touchscreen, voice commands, and the like) operated by the user.

Sub-system 658 may also include other systems 682, such as but not limited to, autonomous or semi-autonomous control systems for autonomous or semi-autonomous control based on the images from image sensors 618. For example, autonomous or semi-autonomous control systems 682 can execute control commands for operating a robotic and/or vehicle system based on amodal images generated from the image obtained by the image sensor 618.

Network 690 may be a conventional type of network, wired or wireless, and may have numerous different configurations including a star configuration, token ring configuration, or other configurations. Furthermore, the network 690 may include a local area network (LAN), a wide area network (WAN) (e.g., the Internet), or other interconnected data paths across which multiple devices and/or entities may communicate. In some embodiments, the network may include a peer-to-peer network. The network may also be coupled to or may include portions of a telecommunications network for sending data in a variety of different communication protocols. In some embodiments, the network 690 includes Bluetooth® communication networks or a cellular communications network for sending and receiving data including via short messaging service (SMS), multimedia messaging service (MMS), hypertext transfer protocol (HTTP), direct data connection, wireless application protocol (WAP), e-mail, DSRC, full-duplex wireless communication, mmWave, Wi-Fi (infrastructure mode), Wi-Fi (ad-hoc mode), visible light communication, TV white space communication and satellite communication. The network may also include a mobile data network that may include 3G, 6G, 5G, LTE, LTE-V2V, LTE-V2I, LTE-V2X, LTE-D2D, VOLTE, 5G-V2X or any other mobile data network or combination of mobile data networks. Further, the network 690 may include one or more IEEE 802.11 wireless networks.

In some embodiments, the network 690 includes a V2X network (e.g., a V2X wireless network). The V2X network is a communication network that enables entities such as elements of the operating environment to wirelessly communicate with one another via one or more of the following: Wi-Fi; cellular communication including 3G, 6G, LTE, 5G, etc.; Dedicated Short Range Communication (DSRC); millimeter wave communication; etc. As described herein, examples of V2X communications include, but are not limited to, one or more of the following: Dedicated Short Range Communication (DSRC) (including Basic Safety Messages (BSMs) and Personal Safety Messages (PSMs), among other types of DSRC communication); Long-Term Evolution (LTE); millimeter wave (mmWave) communication; 3G; 6G; 5G; LTE-V2X; 5G-V2X; LTE-Vehicle-to-Vehicle (LTE-V2V); LTE-Device-to-Device (LTE-D2D); Voice over LTE (VOLTE); etc. In some examples, the V2X communications can include V2V communications, Vehicle-to-Infrastructure (V2I) communications, Vehicle-to-Network (V2N) communications or any combination thereof.

Examples of a wireless message described herein include, but are not limited to, the following messages: a Dedicated Short Range Communication (DSRC) message; a Basic Safety Message (BSM); a Long-Term Evolution (LTE) message; an LTE-V2X message (e.g., an LTE-Vehicle-to-Vehicle (LTE-V2V) message, an LTE-Vehicle-to-Infrastructure (LTE-V2I) message, an LTE-V2N message, etc.); a 5G-V2X message; and a millimeter wave message, etc.

During operation, amodal synthesis circuit 610 may receive sensor data (e.g., one or more image frames from image sensors 618) from sensors 652. Communication circuit 601 can be used to transmit and receive information between amodal synthesis circuit 610 and sensors 652, and amodal synthesis circuit 610 and sub-systems 658. Also, sensors 652 may communicate with sub-systems 658 directly or indirectly (e.g., via communication circuit 601 or otherwise). In an example, images obtained by image sensors 618 can be used as inputs images, which the generative model (e.g., conditional diffusion model) can use to reconstruct amodal images that estimate whole objects contained in the input image, as described above in connection with FIGS. 1-5. The amodal images can be communicated, via communication circuit 601, to sub-systems 658.

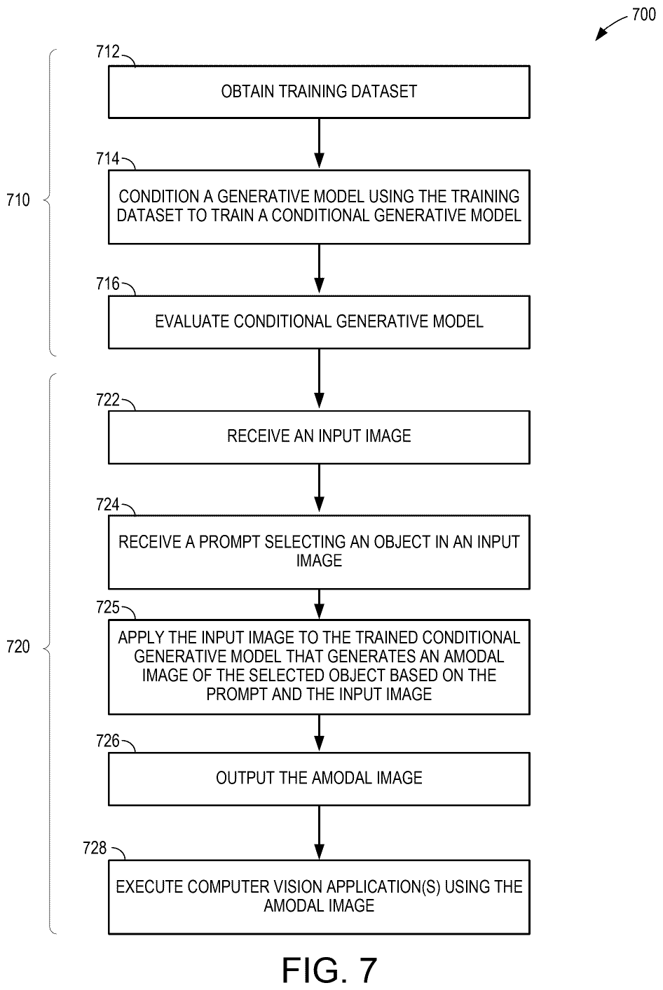

FIG. 7 provides operations that may be carried out in connection with computer implemented method 700, according to one or more embodiments of the present disclosure. For example, computer system 102 of FIG. 1 may implement the operations described herein.

The method 700 comprises a training phase 710 and a run-time phase 720. During training phase 710, method 700 obtains training data and applies the training data to a generative model (e.g., a latent diffusion model in various examples) to train a conditional generative model (e.g., a conditional diffusion model in various examples). During the run-time phase 720, input images may be applied to the trained conditional generative model for generating amodal images of objects specified from the input data. The amodal images, as described above, can be used by downstream computer vision applications.

In more detail, at operation 712, a training data can be obtained. The training dataset may be based on representations and amodal annotations learned by a pre-trained latent diffusion model. In examples, the representations can be used to construct a synthetically curated training dataset of training data pairs, each of which comprise a training occluded image and a corresponding training counterpart image. As described above with reference to FIG. 3, training occluded images can include an occluded object and the training counterpart image comprises the whole of the occluded object (e.g., pixel information of the entire occluded object).

At operation 714, the generative model can be conditioned using the training dataset obtained at operation 712 to train a conditioned generative model. For example, training data pairs of the synthetically curated training dataset can be applied to a latent diffusion model to condition the model to generate amodal representations of the occluded object from the training data pairs. In examples, as described above, prompts selecting an occluded object in a training occluded image can be received based on a user interaction with an input device. The prompts can be used to generate a visible/modal mask for the visible regions of occluded object. Noise can be applied to the training counterpart image, and the latent diffusion model can be conditioned based on the prompt (and/or the mask), the training occluded image, and the noised training counterpart image, for example, as described above in connection with FIG. 5. Examples condition the generative model using two streams: CLIP embeddings to condition the generative model via cross-attention on semantic features of the visible portion of the specified object and VAE embeddings to prove low-level visual details and indicate the visible region of the specified object. The resulting conditional latent diffusion model can estimate an amodal object of the specified occluded object by iteratively denoising the noised training counterpart image. The estimate of the amodal image can be output as pixel information for rendering the whole object. The amodal image can be used to condition the diffusion model to generate amodal images from input images.

At operation 716, the conditional generative model can be evaluated to ensure performance of the model meets expectations. For example, a testing dataset that is similar to the training dataset, but has not yet been applied to the conditional generative model, can be used to test the performance of the model and ensure that accuracy (e.g., how similar the generated amodal image is to an actual counterpart image) meets a desired accuracy threshold. Once the conditional generative model meets the desired threshold (e.g., is trained), the training phase 710 may be complete and the method 700 can proceed to the run-time phase 720.

At operation 722, an input image can be received. The input image may be received from any source. In examples, the input image may be a zero-shot image that has not yet been applied to the conditional generative model or the latent diffusion model. The input image may contain one or more objects that are partially visible due to occlusions by other objects. Thus, the input image may not contain pixel information for the whole of the occluded object.

At operation 724, a prompt can be received selecting an object from the input image. For example, a user may interact with an input device to specify one or more regions of the occluded object contained int eh input image. A modal mask of the visible regions of specified by the prompt(s) can be generated, as described above in connection with FIG. 5.

At operation 725, the prompt (and/or modal mask) and input image can be applied to the conditional generative model. In examples, noise (e.g., Gaussian noise) is applied to the inputs, which the conditional generative model can iteratively denoise to estimate pixel information of the whole of the specified object, including pixel information of occluded regions. In examples, noise can be applied to the modal mask and the input image, which can be concatenated and then iteratively denoised to estimate the occluded pixel information.

At operation 726, an amodal image of the specified object can be output. The amodal image may contain only the estimate pixel information of the specified object. The amodal image can be used for downstream computer vision applications at operation 728, such as but not limited to, image segmentation, object recognition, view synthesis, and 3D reconstruction, as described above.

Although FIG. 7 shows example operations of method 700, in some implementations, method 700 may include additional operations, fewer operations, different operations, or differently arranged operations than those depicted in FIG. 7. Additionally, or alternatively, two or more of the operations of method 700 may be performed in parallel.

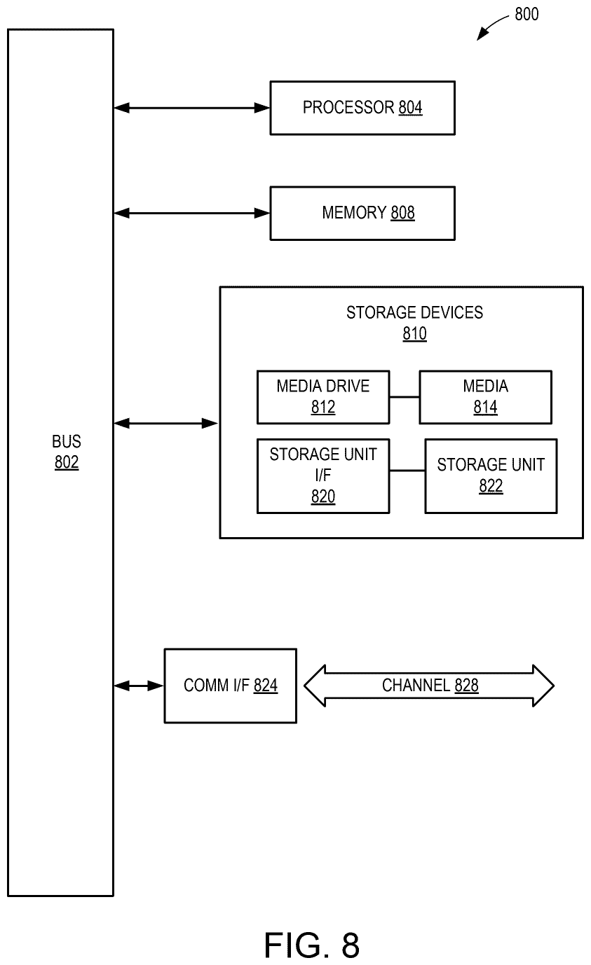

As used herein, the terms circuit and component might describe a given unit of functionality that can be performed in accordance with one or more embodiments of the present application. As used herein, a component might be implemented utilizing any form of hardware, software, or a combination thereof. For example, one or more processors, controllers, ASICs, PLAS, PALs, CPLDs, FPGAs, logical components, software routines or other mechanisms might be implemented to make up a component. Various components described herein may be implemented as discrete components or described functions and features can be shared in part or in total among one or more components. In other words, as would be apparent to one of ordinary skill in the art after reading this description, the various features and functionality described herein may be implemented in any given application. They can be implemented in one or more separate or shared components in various combinations and permutations. Although various features or functional elements may be individually described or claimed as separate components, it should be understood that these features/functionality can be shared among one or more common software and hardware elements. Such a description shall not require or imply that separate hardware or software components are used to implement such features or functionality.

Where components are implemented in whole or in part using software, these software elements can be implemented to operate with a computing or processing component capable of carrying out the functionality described with respect thereto. One such example computing component is shown in FIG. 8. Various embodiments are described in terms of this example-computing component 800. After reading this description, it will become apparent to a person skilled in the relevant art how to implement the application using other computing components or architectures.

Referring now to FIG. 8, computing component 800 may represent, for example, computing or processing capabilities found within a self-adjusting display, desktop, laptop, notebook, and tablet computers. They may be found in hand-held computing devices (tablets, PDA's, smart phones, cell phones, palmtops, etc.). They may be found in workstations or other devices with displays, servers, or any other type of special-purpose or general-purpose computing devices as may be desirable or appropriate for a given application or environment. Computing component 800 might also represent computing capabilities embedded within or otherwise available to a given device. For example, a computing component might be found in other electronic devices such as, for example, portable computing devices, and other electronic devices that might include some form of processing capability.

Computing component 800 might include, for example, one or more processors, controllers, control components, or other processing devices. This can include a processor, and/or any one or more of the components making up of the computer system 102 of FIG. 1 and/or computer vision system 600 of FIG. 6. Processor 804 might be implemented using a general-purpose or special-purpose processing engine such as, for example, a microprocessor, controller, or other control logic. Processor 804 may be connected to a bus 802. However, any communication medium can be used to facilitate interaction with other components of computing component 800 or to communicate externally.

Computing component 800 might also include one or more memory components, simply referred to herein as main memory 808. For example, random access memory (RAM) or other dynamic memory, might be used for storing information and instructions to be executed by processor 804. Main memory 808 may store instructions for executing operations described in connection with one or more of FIGS. 1-5 and 7. Main memory 808 might also be used for storing temporary variables or other intermediate information during execution of instructions to be executed by processor 804. Computing component 800 might likewise include a read only memory (“ROM”) or other static storage device coupled to bus 802 for storing static information and instructions for processor 804.

The computing component 800 might also include one or more various forms of information storage mechanism 810, which might include, for example, a media drive 812 and a storage unit interface 820. The media drive 812 might include a drive or other mechanism to support fixed or removable storage media 814. For example, a hard disk drive, a solid-state drive, a magnetic tape drive, an optical drive, a compact disc (CD) or digital video disc (DVD) drive (R or RW), or other removable or fixed media drive might be provided. Storage media 814 might include, for example, a hard disk, an integrated circuit assembly, magnetic tape, cartridge, optical disk, a CD or DVD. Storage media 814 may be any other fixed or removable medium that is read by, written to or accessed by media drive 812. As these examples illustrate, the storage media 814 can include a computer usable storage medium having stored therein computer software or data.

In alternative embodiments, information storage mechanism 810 might include other similar instrumentalities for allowing computer programs or other instructions or data to be loaded into computing component 800. Such instrumentalities might include, for example, a fixed or removable storage unit 822 and an interface 820. Examples of such storage units 822 and interfaces 820 can include a program cartridge and cartridge interface, a removable memory (for example, a flash memory or other removable memory component) and memory slot. Other examples may include a PCMCIA slot and card, and other fixed or removable storage units 822 and interfaces 820 that allow software and data to be transferred from storage unit 822 to computing component 800.

Computing component 800 might also include a communications interface 824. Communications interface 824 might be used to allow software and data to be transferred between computing component 800 and external devices. Examples of communications interface 824 might include a modem or soft modem, a network interface (such as Ethernet, network interface card, IEEE 802.XX or other interface). Other examples include a communications port (such as for example, a USB port, IR port, RS232 port Bluetooth® interface, or other port), or other communications interface. Software/data transferred via communications interface 824 may be carried on signals, which can be electronic, electromagnetic (which includes optical) or other signals capable of being exchanged by a given communications interface 824. These signals might be provided to communications interface 824 via a channel 828. Channel 828 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media. Such media may be, e.g., memory 808, storage unit 822, media 814, and channel 828. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 800 to perform features or functions of the present application as discussed herein.

It should be understood that the various features, aspects and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A method comprising:
receiving a prompt selecting an object in an input image;
applying the input image to a trained conditional generative model that generates an amodal image of the selected object based on the prompt and the input image; and
outputting the amodal image.

2. The method of claim 1, wherein the input image is a zero-shot image that has not been previously applied to the trained conditional generative model.

3. The method of claim 1, wherein the object is an occluded object that is partially visible in the input image.

4. The method of claim 3, further comprising:
creating a mask of a visible portion of the selected object based on the prompt; and
inputting the mask into the trained conditional generative model,
wherein the trained conditional generative model generates the amodal image of the selected object by synthesizing occluded portions of the object.

5. The method of claim 1, wherein the trained conditional generative model is based a training dataset comprising training occluded images comprising occluded objects and training counterpart images of whole object counterparts of the occluded objects.

6. The method of claim 5, further comprising:
building the training dataset from a plurality of source images by:
identifying candidate objects contained in the plurality of source images and selecting the candidate objects as a whole object based on an estimate depth of the candidate object;
extracting a first selected whole object from a first source image of the plurality of source images to generate a first training counterpart image and extracting a second selected whole object from a second source image of the plurality of source images to generate a second training counterpart image;
superimposing the first training counterpart image over the second source image to generate a training occluded image; and
associating the second training counterpart image with the training occluded image, wherein the second training counterpart image and the training occluded image constitute a training data pair.

7. The method of claim 5, wherein the conditional generative model is a conditional diffusion model.

8. The method of claim 7, further comprising:
conditioning a trained latent diffusion model using the training dataset to train the conditional diffusion model.

9. The method of claim 8, wherein conditioning the trained latent diffusion model further comprises, for each occluded image of the training dataset:
receiving a prompt that selects an occluded object in the training occluded image;
generating a mask of a visible region of the occluded object based on the prompt;
applying noise to the training counterpart image; and
conditioning the trained latent diffusion model based on the prompt, the mask, the training occluded image, and the noised training counterpart image.

10. The method of claim 9, wherein the conditioned trained latent diffusion model generates a reconstruction of the training counterpart image by denoising the noised training counterpart image.

11. A system, comprising:
a memory storing instructions; and
a processor communicatively coupled to the memory and configured to execute the instructions to:
receive a prompt selecting an object in an input image;
apply the input image to a trained conditional generative model that generates an amodal image of the selected object based on the prompt and the input image; and
output the amodal image.

12. The system of claim 11, wherein the input image is a zero-shot image that has not been previously applied to the trained conditional generative model.

13. The system of claim 11, wherein the object is an occluded object that is partially visible in the input image.

14. The system of claim 13, wherein the processor is further configured to execute the instructions to:
create a mask of a visible portion of the selected object based on the prompt; and
input the mask into the trained conditional diffusion model,
wherein the trained conditional diffusion model generates the amodal image of the selected object by synthesizing occluded portions of the object.

15. The system of claim 11, wherein the trained conditional diffusion model is based a training dataset comprising training occluded images comprising occluded objects and training counterpart images of whole object counterparts of the occluded objects.

16. The system of claim 15, wherein the conditional generative model is a conditional diffusion model.

17. The system of claim 16, wherein the processor is further configured to execute the instructions to:
condition a trained latent diffusion model using the training dataset to train the conditional diffusion model.

18. The system of claim 17, wherein conditioning the trained latent diffusion model further comprises, for each occluded image of the training dataset:
receiving a prompt that selects an occluded object in the training occluded image;
generating a mask of a visible region of the occluded object based on the prompt;
applying noise to the training counterpart image; and
conditioning the trained latent diffusion model based on the prompt, the mask, the training occluded image, and the noised training counterpart image.

19. A non-transitory machine-readable medium having instructions stored therein, which when executed by a processor, cause the processor to perform operations, the operations comprising:
building a synthetically curated training dataset by generating training data pairs from source images, each training data pair comprising a training occluded image of an occluded object and a training counterpart image of a whole object corresponding to the occluded object; and
conditioning a latent diffusion model to generate an amodal image of an occluded object in an input image based on the synthetically curated training dataset.

20. The non-transitory machine-readable medium of claim 19, wherein the operations further comprise:
for each source image, identifying a candidate object contained in the source image and select the candidate object as a whole object based on an estimate depth of the candidate object;
extracting, from a first source image, a first whole object to generate a first training counterpart image and extracting, from a second source image, a second whole object to generate a second training counterpart image;
superimposing the first training counterpart image over the second source image to generate a training occluded image; and
associating the second training counterpart image with the training occluded image, wherein the second training counterpart image and the training occluded image constitute a training data pair.
